(19) United States
(12) Patent Application Publication
(10) Pub. No.: US 2008/0226218 A1
(43) Pub. Date: Sep. 18, 2008

(54) Collision detection optical fiber sensor

(75) Inventors: Tomiya Abe, Hitachi (JP); Yasuyuki Hishida, Hitachi (JP); Mitsuo Takaba, Hitachi (JP); Satoshi Yamamoto, Hitachi (JP); Katsushi Tsutsuda, Hitachi (JP); Akira Suzuki, Hekinan (JP); Shigenori Kobayashi, Hazugun (JP)

Correspondence Address: SCULLY SCOTT MURPHY & PRESSER, PC, 400 GARDEN CITY PLAZA, SUITE 300, GARDEN CITY, NY, 11530, US

(73) Assignees: Hitachi Cable LTD., Tokyo (JP); Denso Corporation, Aichi (JP)

(21) Appl. No.: 11/978,739

(22) Filed: Oct. 30, 2007

(30) Foreign Application Priority Data
Oct. 31, 2006 (JP) 2006-295764

(51) Int. Cl. G02B 6/00

(52) U.S. Cl. 385/13

(57) ABSTRACT

An optical fiber 1 includes a core 11 and a cladding material 12. In a collision detection optical fiber sensor 100, a plurality of linear members 2 and 3 are twisted around an outer periphery of the cladding material 12 of the optical fiber 1. An elastic member 6 of the liner member 2 has an elasticity different from that of an elastic member 7 of the first linear member 3. The hardness of the elastic member 6 is lower than that of the elastic member 7. A rubber hardness difference measured by a durometer type A according to a JIS K6253 between the elastic member 6 and the elastic member 7 is not less than 10.

The present application is based on Japanese Patent Application No. 2006-295764 filed on Oct. 31, 2006, the entire contents of which are incorporated herein by reference.

### BACKGROUND OF THE INVENTION

1. Field of the Invention

The present invention relates to a collision detection optical fiber sensor for detecting a collision.

2. Related Art

As an impact detecting sensor for detecting an impact such as collision applied to an object, there is a sensor using an optical fiber. In an optical fiber type sensor, when the impact is applied to the object, bending or warping occurs in an optical fiber, so that the impact is detected by detecting a variation in quantity of a light propagated through the optical fiber, due to a bending loss and a compression loss. Such optical sensor is generally called as “collision detection optical fiber sensor”.

As the collision detection optical fiber type sensors, Japanese Patent Publication No. 6-48220, Japanese Patent Laid-Open No. 2005-207768, Japanese Patent Laid-Open No. 2005-031067, and Japanese Patent Laid-Open No. 2002-286561 respectively disclose sensors, in each of which a filament, a spiral wire, an insulated linear member or the like is spirally wound at an outer periphery of an optical fiber such that bending or warping easily occurs in the optical fiber, for the purpose of improving a sensitivity.

However, according to the conventional optical fiber sensors, there is a disadvantage in that the sensitivity of the sensor cannot be obtained enough, since the optical fiber has a high rigidity, so that an optical transmission loss due to the bending or the compression is difficult to occur.

### SUMMARY OF THE INVENTION

Therefore, an object of the invention is to provide a collision detection optical fiber sensor with high sensitivity and high precision.

According to a feature of the present invention, a collision detection optical fiber sensor comprises:

an optical fiber including a core and a cladding material;

a first linear member having an elasticity and twisted around an outer periphery of the cladding material; and

a second linear member having an elasticity different from that of the first linear member, and twisted around the outer periphery of the cladding material together with the first linear member.

Further, in the collision detection optical fiber sensor, the first linear member and the second linear member may be disposed alternately along a circumferential direction of the optical fiber to be twisted around the optical fiber.

Still further, in the collision detection optical fiber sensor, a first linear member group comprising a plurality of the first linear member and a second linear member group comprising a plurality of the second linear members may be disposed alternately along a circumferential direction of the optical fiber to be twisted around the optical fiber.

In the collision detection optical fiber sensor, each of the first linear member and the second linear member may comprise a tension member and an elastic member covering an outer periphery of the tension member.

In the collision detection optical fiber sensor, each of the first linear member and the second-linear member may comprise an elastic member with a string-shape.

In the collision detection optical fiber sensor, it is preferable that a rubber hardness difference measured by a durometer type A according to a JIS K6253 between the elastic member of the-first linear member and the elastic member of the second linear member is not less than 10.

In the collision detection optical fiber sensor, the elastic member may comprise a silicone rubber.

In the collision detection optical fiber sensor, the tension member may comprise a copper wire.

In the collision detection optical fiber sensor, each of the first linear member and the second linear member may consist of an elastic member with a string-shape.

According to the present invention, it is possible to provide a collision detection optical fiber sensor with high sensitivity and high precision.

### BRIEF DESCRIPTION OF THE DRAWINGS

The present invention will be explained in more detail in conjunction with appended drawings, wherein:

FIGS. 1A and 1B are schematic diagrams showing a collision detection optical fiber sensor in a first preferred embodiment according to the invention, wherein FIG. 1A is a cross sectional view thereof, and FIG. 1B is a side view thereof;

FIG. 2 is an explanatory diagram showing an example of using the collision detection optical fiber sensor;

FIG. 3 is an explanatory diagram showing the collision detection optical fiber sensor of FIG. 2 in a state that a bending deformation is occurred by applying a load;

FIGS. 4A and 4B are schematic diagrams showing a collision detection optical fiber sensor in a second preferred embodiment according to the invention, wherein FIG. 4A is a cross sectional view thereof, and FIG. 4B is a side view thereof;

FIGS. 5A and 5B are schematic diagrams showing a collision detection optical fiber sensor in a third preferred embodiment according to the invention, wherein FIG. 5A is a cross sectional view thereof, and FIG. 5B is a side view thereof;

FIGS. 6A and 6B are schematic diagrams showing a collision detection optical fiber sensor in a fourth preferred embodiment according to the invention, wherein FIG. 6A is a cross sectional view thereof, and FIG. 6B is a side view thereof;

FIG. 7 is a characteristic diagram showing a relationship between hardness difference and sensitivity in Examples 1, 2, 4 to 8 shown in TABLE 1; and

FIG. 8 is a characteristic diagram showing a relationship between hardness difference and sensitivity in Examples 9, 10, 12 to 15 shown in TABLE 2.

### DETAILED DESCRIPTION OF THE PREFERRED EMBODIMENTS

Next, the preferred embodiments according to the present invention will be explained in more detail in conjunction with the appended drawings.

### First Preferred Embodiment

(Structure of Collision Detection Optical Fiber Sensor)

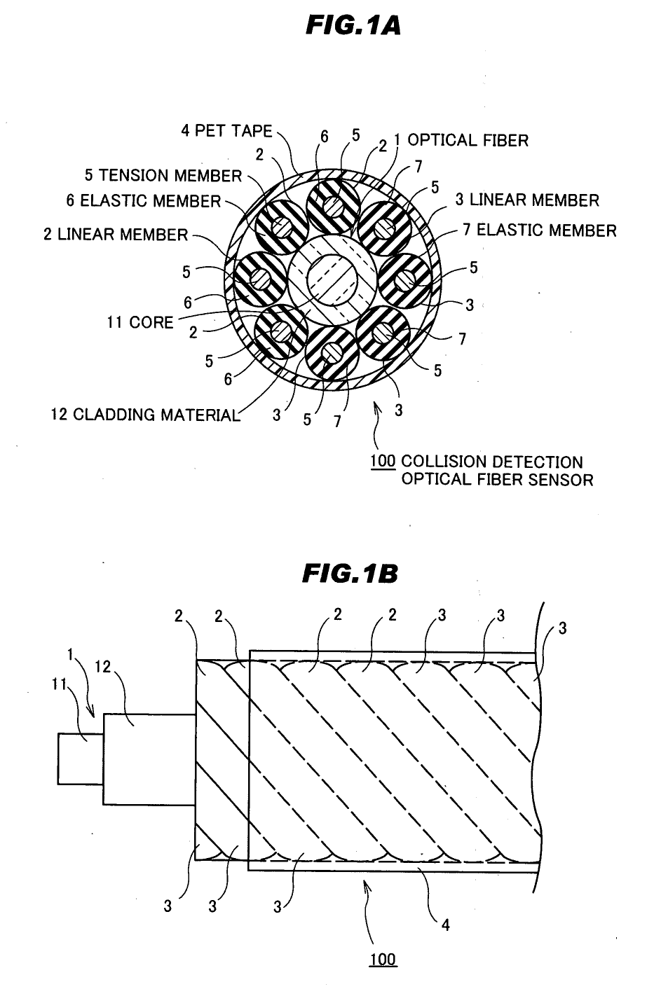

FIGS. 1A and 1B are schematic diagrams showing a collision detection optical fiber sensor in a first preferred embodiment according to the invention, wherein FIG. 1A is a cross sectional view thereof, and FIG. 1B is a side view thereof.

As shown in FIG. 1A, a collision detection optical fiber sensor 100 comprises an optical fiber 1 composed of a synthetic resin that is disposed at a center of the collision detection optical fiber sensor 100, four linear members (first linear members) 2 arranged to be twisted around an outer periphery of the optical fiber 1, four linear members (second linear members) 3 having an elasticity lower than (namely, harder than) that of the first linear members 4, and a PET tape 4 wound around an outer periphery of the first and second linear members 2, 3.

The optical fiber 1 comprises a core 11 and a cladding material 12 provided around the core 11, and the core 11 has a refractive index higher than that of the cladding material 12.

The core 11 has a function of transmitting a light. A material of the core 11 is not particularly limited if the material has an optical transmission function. For example, acrylic resin represented by polymethyl methacrylate, aromatic resin represented by polystyrene and polycarbonate, or alicyclic transparent resin may be used. Further, for the purpose of improving heat resistance or durability, a crosslinked polymer which is fabricated by crosslinking process after doping a crosslinking agent to the aforementioned resin. As the crosslinked polymer, crosslinked acrylic resin (thermosetting acrylic resin), silicone resin or the like may be used.

The cladding material 12 has a function of confining the light propagating through the core 11 within the core 11, and has the refractive index smaller than that of the core 11. As a material of the cladding material 12, fluorine based resin such as fluorinated acrylate resin, fluorinated vinylidene, tetrafluoroethylene resin (TFE), tetrafluoroethylene/hexafluoropropylene copolymer (FEP), tetrafluoroethylene/perfluoroalkyl vinylether copolymer (PFA), ethylene tetrafluoroethylene copolymer (ETFE), fluorinated vinylidene/tetrafluoroethylene/hexafluoropropylene terpolymer, silicone rubber or the like may be used.

As to the structure of the optical fiber, it is essential to be composed of the core and the cladding material provided outside the core. Further, the optical fiber 1 may further comprise a jacket layer provided at the outer periphery of the cladding material 12 as necessary, so as to protect the core 11 and the cladding material 12 from an external damage.

As a material of the jacket layer, polyethylene, nylon, ethylene-tetrafluoroethylene copolymer (ETFE), soft polyvinylchloride (PVC), rubber, or the like may be used.

The first linear member 2 comprises a tension member 5 as a core, and an elastic member (first elastic member) 6 covering the tension member 5. Similarly, the second linear member 3 comprises the tension member 5 as a core, and an elastic member (second elastic member) 7 covering the tension member 5. The first elastic member 6 has an elasticity different from that of the second elastic member 7.

In the first preferred embodiment, the first and second linear members 2, 3 are wound around the optical fiber 1, in a state that the first and second linear members 2, 3 are classified into first and second groups (first and second linear member groups) each having four linear members. The second elastic member 7 of the second linear member 3 has the elasticity lower than that of the first elastic member 6 of the first linear member 2. It is preferable that a rubber hardness of the linear member 2 is different from that of the linear member 3 by not less than 10 in rubber hardness measured by a durometer type A according to a JIS (Japanese Industrial Standard) “K6253”.

As the tension member 5, a string of fibers such as copper wire, aluminum wire, FRP (Fiber Reinforced Plastics) may be used. In particular, the copper wire is preferable since it may be used as a power source or a signal line of a circuitry.

As the elastic members 6, 7, a rubber having elasticity or a thermoplastic elastomer is used, since it is necessary to restore a deformation of the optical fiber 1 when a stress to the optical fiber 1 is released. In particular, it is preferable to use a silicone rubber, since the silicone rubber has a characteristic that a variation in elasticity modulus (hardness) is small within a range from a low temperature to a high temperature.

(Operation of the Collision Detection Optical Fiber Sensor)

Next, operation of the collision detection optical fiber sensor 100 will be explained below.

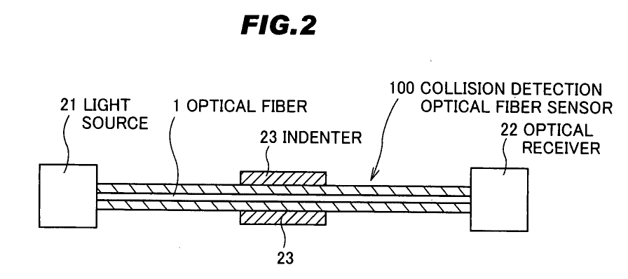

FIG. 2 is an explanatory diagram showing an example of using the collision detection optical fiber sensor.

In the optical fiber 1, a light source 21 (for example, a light emitting diode having a wavelength of 650 nm) is connected at one end, and an optical receiver 22 (for example, a photodiode) is connected at another end. Furthermore, the optical fiber 1 is outwardly engaged with an indenter 23.

A principle of the operation of the collision detection optical fiber sensor 100 is that a bending deformation occurs in the optical fiber 1 due to a stress applied to a lateral face of the optical fiber 1, an optical transmission characteristic is varied (namely, attenuated) by this bending deformation, and application of the stress, namely application of the impact (collision) is sensed by detecting this variation.

The Inventors studied a relationship between a bending deformation and rubber hardness of the linear members and found a principle as below. When a combination of linear members having more than two kinds of rubber hardness (soft and hard), preferably with a hardness difference of not less than 10, is used as the first and second linear members 2, 3, a region of a lateral face of the optical fiber 1 pressed by the second linear member 3 using the hard elastic member 7 deforms largely, while another region of the lateral face of the optical fiber 1 pressed by the first linear member 2 using the soft elastic member 6 deforms small. As a result, the bending deformation which occurs in the optical fiber 1 is increased, and the variation in the optical transmission loss due to the stress is increased, compared with a case that a rubber covered wire with a uniform hardness is used for the linear members.

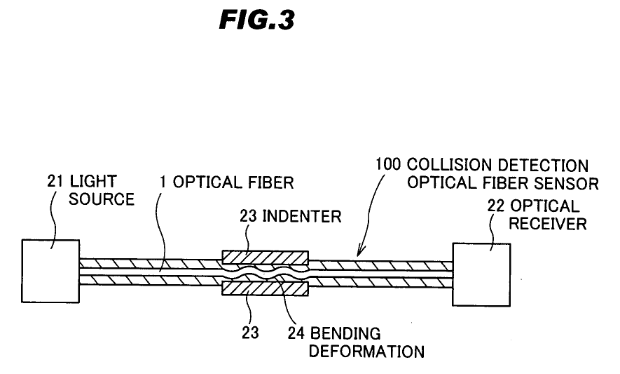

FIG. 3 is an explanatory diagram showing the collision detection optical fiber sensor of FIG. 2 in a state that a bending deformation is occurred by applying a load.

When a load is applied from the indenter 23 to the optical fiber 1, a pressure is applied to the core 11 in accordance with the different hardness of the first and second elastic member 6, 7, so that a small bending deformation 24 occurs. An optical transmission loss occurs due to the bending deformation 24 thus occurred, and a light arriving at the optical receiver 22 from the light source 21 is decreased. A variation in the light arriving at the optical receiver 22 is measured to calculate the optical transmission loss, and an amount of the optical transmission loss is converted into the load, thereby realizing a load detection. When the load from the indenter 23 is released, the deformation of the optical fiber 1 immediately recovers by elastic forces of the elastic members 6, 7 and the first and second linear members 2, 3 themselves, so that an optical transmission characteristic is restored to its original state.

Since the first and second linear members 2 and 3 are twisted, a convexo-concave shape is precisely and effectively formed at the lateral face of the optical fiber 1, when the stress is applied to the lateral face of the optical fiber 1. In addition, the first and second elastic members 6, 7 function as members for applying a pressure to the lateral face of the optical fiber 1.

### Effect of the First Preferred Embodiment

According to the first preferred embodiment, following effects can be obtained.

(1) By providing the first and second linear members 2 and 3 having different hardness (soft and hard) from each other, a degree of the deformation given by the first and second linear members 2, 3 to the lateral face of the optical fiber 1 can be changed, so that it is possible to improve a sensor sensitivity of the collision detection optical fiber sensor 100.

(2) By providing the tension member 5 in the center of each of the first and second linear members 2 and 3, strength of the linear members along a longitudinal direction can be assured, so that it is possible to wind the first and second linear members 2, 3 around the outer periphery of the optical fiber 1.

(3) By using the silicone rubber having a characteristic that a variation in elasticity modulus (hardness) is small within a range from −30° C. to 70° C. as the elastic members 6 and 7, it is possible to obtain the collision detection optical fiber sensor 100 having stable stress-optical loss variation characteristics from −30° C. to 70° C., even if the collision detection optical fiber sensor 100 is employed in a wide temperature range.

### Second Preferred Embodiment

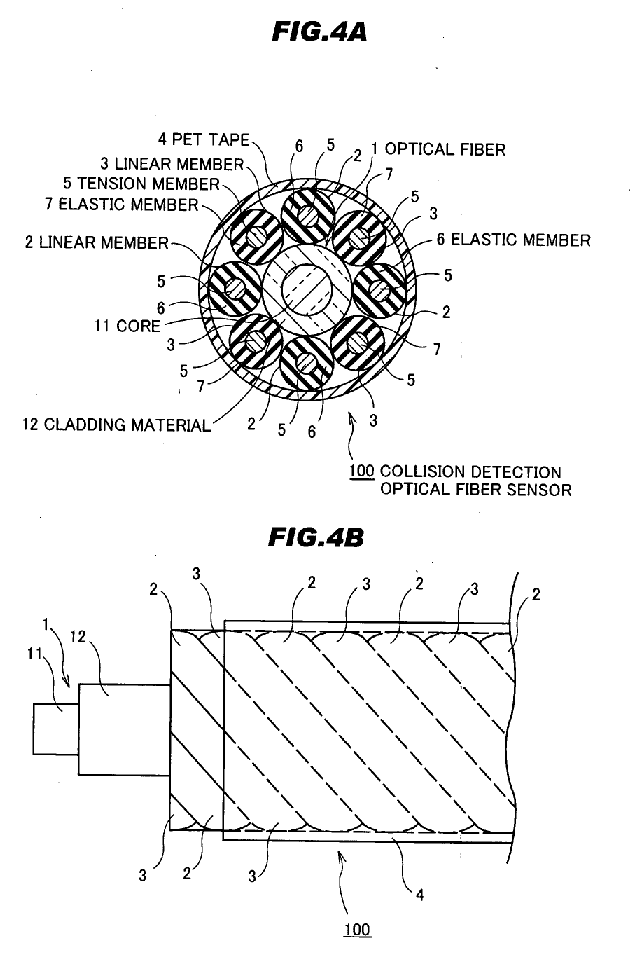

FIGS. 4A and 4B are schematic diagrams showing a collision detection optical fiber sensor in a second preferred embodiment according to the invention, wherein FIG. 4A is a cross sectional view thereof, and FIG. 4B is a side view thereof.

The second preferred embodiment is similar to the first preferred embodiment, except that the first and second linear members 2 and 3 are disposed alternately along a circumferential direction of the outer periphery of the optical fiber 1, in place of providing the linear member groups comprising a plurality of the first and second linear members 2 and 3.

According to the second preferred embodiment, it is possible to improve a sensor sensitivity of the collision detection optical fiber sensor 100 as well as to obtain the collision detection optical fiber sensor 100 having stable stress-optical loss variation characteristics from the low temperature to the high temperature.

### Third Preferred Embodiment

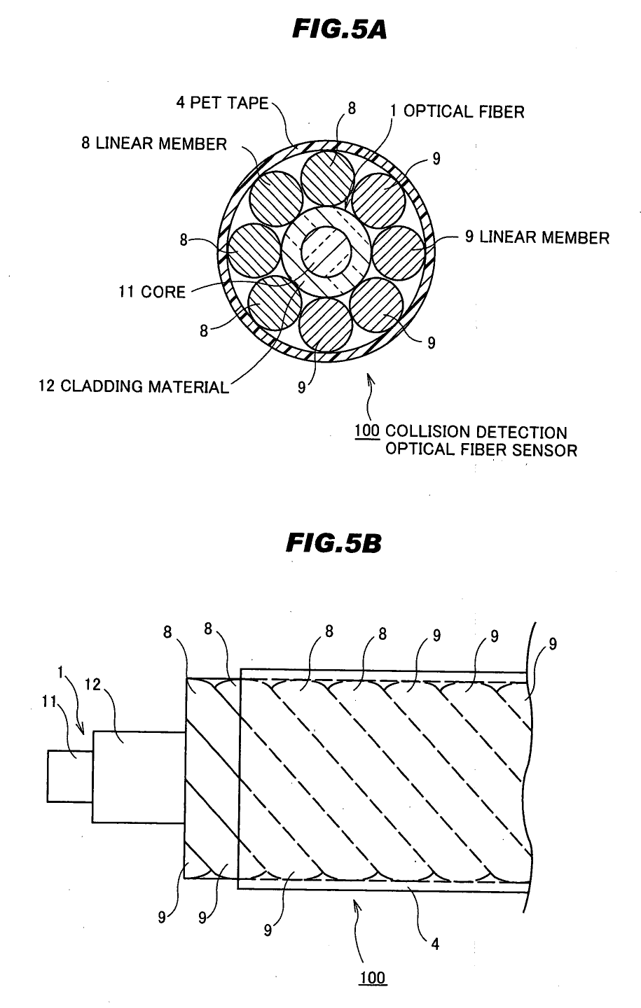

FIGS. 5A and 5B are schematic diagrams showing a collision detection optical fiber sensor in a third preferred embodiment according to the invention, wherein FIG. 5A is a cross sectional view thereof, and FIG. 5B is a side view thereof.

The third preferred embodiment is similar to the second preferred embodiment shown in FIG. 4A and FIG. 4B, the collision detection optical fiber sensor 100 comprises linear members 8, 9, each of which consists of a string-shaped elastic material, in place of the linear members 2, 3. Namely, each of the linear member 8, 9 has a configuration in that the tension member 5 is removed from each of the linear member 2, 3. Four linear members 8 constitute a first linear member group and another four linear members 9 constitute a second linear member group. The hardness of the string-shaped linear members 8 and 9 are different from each other.

According to the third preferred embodiment, it is possible to improve a sensor sensitivity of the collision detection optical fiber sensor 100, since the hardness of the string-shaped linear members 8 and 9 are different from each other.

### Fourth Preferred Embodiment

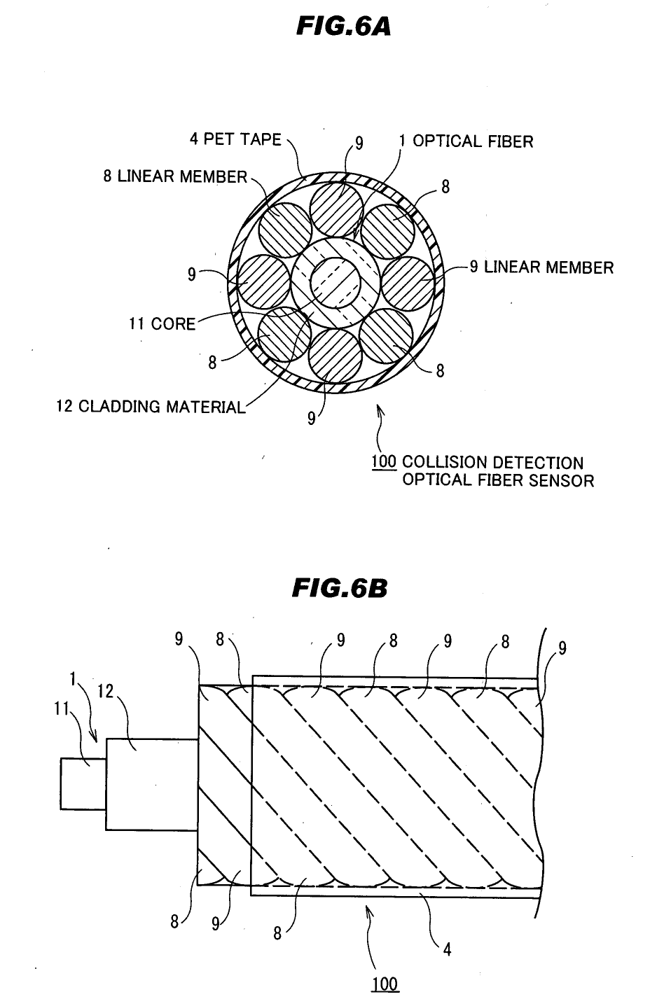

FIGS. 6A and 6B are schematic diagrams showing a collision detection optical fiber sensor in a fourth preferred embodiment according to the invention, wherein FIG. 6A is a cross sectional view thereof, and FIG. 6B is a side view thereof.

The fourth preferred embodiment is similar to the third preferred embodiment shown in FIGS. 5A and 5B, except that the linear members 8 and 9 are disposed alternately along a circumferential direction of the outer periphery of the optical fiber 1, in place of providing the first and second linear member groups comprising a plurality of the first and second linear members 8 and 9.

According to the fourth preferred embodiment, it is possible to improve a sensor sensitivity of the collision detection optical fiber sensor 100 as well as to obtain the collision detection optical fiber sensor 100 having stable stress-optical loss variation characteristics from the low temperature to the high temperature.

### EXAMPLE 1

Next, Examples according to the present invention will be explained below.

### Examples 1 to 8

TABLE 1 is a table showing Examples 1 to 8 of the collision detection optical fiber sensor 100 according to the first preferred embodiment, in which the linear members 2 each comprising the tension member 5 composed of the copper wire and the elastic members 6 and the linear members 3 each comprising the tension member 5 composed of the copper wire and the elastic members 7 are wound around the optical fiber 1.

TABLE 1

| | Diameter of | | | | | | |
|---|---|---|---|---|---|---|---|
| | tension member/ | Hardness | Hardness | | | | |
| | Diameter of elastic | of elastic | of elastic | Hardness | Sensitivity | Sensitivity | Sensitivity |
| Example | member | member 6 | member 7 | difference | (−30□) | (20□) | (70□) |
| 1 | Copper wire 0.3 mm/ | 40 | 65 | 25 | 0.27 | 0.3 | 0.306 |
| | Silicone rubber | | | | | | |
| | 1.0 mm | | | | | | |
| 2 | Copper wire 0.3 mm/ | 50 | 50 | 0 | 0.075 | 0.09 | 0.105 |
| | Silicone rubber | | | | | | |
| | 1.0 mm | | | | | | |
| 3 | Copper wire 0.3 mm/ | 40 | 65 | 25 | 0.06 | 0.3 | 1.17 |
| | Ethylene | | | | | | |
| | Propylene rubber | | | | | | |
| | 1.0 mm | | | | | | |
| 4 | Copper wire 0.3 mm/ | 50 | 53 | 3 | 0.075 | 0.105 | 0.096 |
| | Silicone rubber | | | | | | |
| | 1.0 mm | | | | | | |
| 5 | Copper wire 0.3 mm/ | 50 | 65 | 15 | 0.24 | 0.255 | 0.33 |
| | Silicone rubber | | | | | | |
| | 1.0 mm | | | | | | |
| 6 | Copper wire 0.3 mm/ | 50 | 65 | 15 | 0.24 | 0.27 | 0.33 |
| | Silicone rubber | | | | | | |
| | 1.0 mm | | | | | | |
| 7 | Copper wire 0.3 mm/ | 40 | 70 | 30 | 0.27 | 0.33 | 0.36 |
| | Silicone rubber | | | | | | |
| | 1.0 mm | | | | | | |
| 8 | Copper wire 0.3 mm/ | 50 | 60 | 10 | 0.18 | 0.189 | 0.21 |
| | Silicone rubber | | | | | | |
| | 1.0 mm | | | | | | |

In the Examples 1 to 8, the optical fiber 1 comprises a core 11 comprising a crosslinked acrylic resin with an outer diameter of 1.5 mm, and a cladding material 12 comprising a fluororesin with an outer diameter of 2.2 mm.

The tension member 5 comprises a copper wire with an outer diameter of 0.3 mm, and each of the elastic members 6, 7 for covering the tension member 5 has a thickness of 0.35 mm and various hardness as shown in TABLE 1.

Four linear members 2 and four linear members 3 are disposed continuously in two groups as shown in FIG. 1A and the linear members 2, 3 are twisted as shown in FIG. 1B to be wound around the optical fiber 1. A winding pitch is 40 mm. After winding eight linear members 2 and 3 around the optical fiber 1, a PET tape 4 with a thickness of 5 μm is wound such that the winding will not come loose.

The sensitivity of the sensor is defined by an optical transmission loss, which occurs when a load of 1 KN is applied to a 100 mm area at a center of the collision detection optical fiber sensor 100 having a length of 1 m. Measurement is conducted as follows. As shown in FIG. 2, a light emitted from an LED with a wavelength of 650 nm is input from a light source 21 to one end of the collision detection optical fiber sensor 100, and the light output from another end is received at an optical power meter as an optical receiver 22.

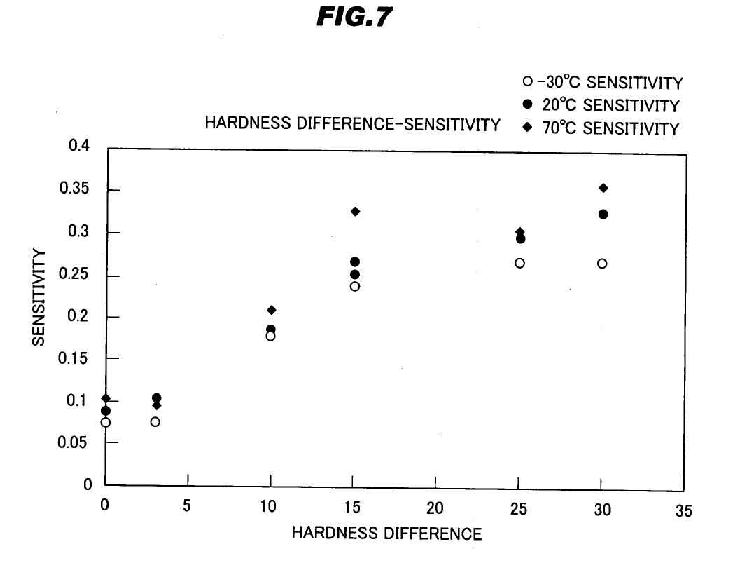

FIG. 7 is a characteristic diagram showing a relationship between hardness difference and sensitivity in Examples 1, 2, 4 to 8 shown in TABLE 1.

As shown in FIG. 7, the sensitivity is improved in accordance with the increase in the hardness difference between the elastic members 6 and 7. The hardness difference is preferably not less than 10, by which the sensitivity is generally not less than 0.2. The hardness difference is more preferably not less than 15.

By comparing the Example 3 with the Example 1 in that the hardness differences are 25, it is confirmed that the variation in the sensitivity in the Example 1 using the silicone rubber as the elastic member is smaller that in the Example 3 using the ethylene propylene rubber as the elastic member within a temperature variation from −30° C. to 70° C.

### Examples 9 to 15

TABLE 2 is a table showing Examples 9 to 15 of the collision detection optical fiber sensor 100 according to the third preferred embodiment, in which each of the linear members 8, 9 does not comprise the tension member 5.

TABLE 2

| | | Hardness | Hardness | | | | |
|---|---|---|---|---|---|---|---|
| | Diameter of linear | of linear | of linear | Hardness | Sensitivity | Sensitivity | Sensitivity |
| Example | members | member 8 | member 9 | Difference | (−30□) | (20□) | (70□) |
| 9 | Silicone rubber | 40 | 70 | 30 | 0.255 | 0.3 | 0.315 |
| | string 1.0 mm | | | | | | |
| 10 | Silicone rubber | 50 | 50 | 0 | 0.105 | 0.12 | 0.135 |
| | string 1.0 mm | | | | | | |
| 11 | Ethylene | 40 | 65 | 25 | 0.09 | 0.3 | 1.26 |
| | Propylene rubber | | | | | | |
| | string 1.0 mm | | | | | | |
| 12 | Silicone rubber | 50 | 60 | 10 | 0.18 | 0.195 | 0.21 |
| | string 1.0 mm | | | | | | |
| 13 | Silicone rubber | 55 | 60 | 5 | 0.135 | 0.165 | 0.18 |
| | string 1.0 mm | | | | | | |
| 14 | Silicone rubber | 50 | 65 | 15 | 0.21 | 0.24 | 0.3 |
| | string 1.0 mm | | | | | | |
| 15 | Silicone rubber | 40 | 65 | 25 | 0.24 | 0.285 | 0.33 |
| | string 1.0 mm | | | | | | |

In the Examples 9 to 15, the optical fiber 1 comprises a core 11 comprising a crosslinked acrylic resin with an outer diameter of 1.5 mm a cladding material 12 comprising a fluororesin with an outer diameter of 2.2 mm. Four linear members 8 and four linear members 9 are disposed continuously in two groups as shown in FIG. 5A and the linear members 8, 9 are twisted as shown in FIG. 5B to be wound around the optical fiber 1. A winding pitch is 40 mm. After winding eight linear members 8 and 9 around the optical fiber 1, a PET tape 4 with a thickness of 5 μm is wound such that the winding will not come loose.

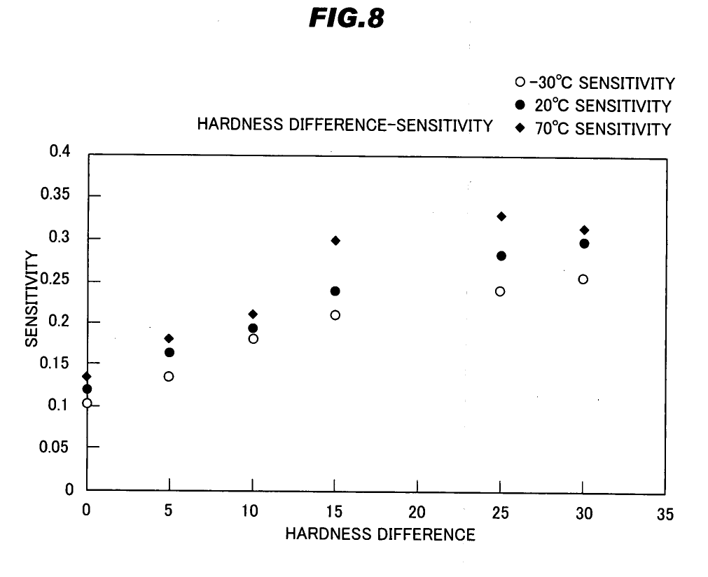

FIG. 8 is a characteristic diagram showing a relationship between hardness difference and sensitivity in Examples 9, 10, 12 to 15 shown in TABLE 2. As shown in FIG. 8, the sensitivity is improved in accordance with the increase in the hardness difference between the elastic member composing the linear member 8 and the elastic member composing the linear member 9. The hardness difference is preferably not less than 10, by which the sensitivity is generally not less than 0.2. The hardness difference is more preferably not less than 15.

By comparing the Example 15 with the Example 11 in that the hardness differences are 25, it is confirmed that the variation in the sensitivity in the Example 15 using the silicone rubber as the elastic member is smaller that in the Example 11 using the ethylene propylene rubber as the elastic member within a temperature variation from −30° C. to 70° C.

In addition, the present invention is not limited to the preferred embodiments as described above, and various modifications can be made without going beyond the scope of the invention. For example, a combination of elements in the respective preferred embodiments can be made arbitrarily. For example, it is possible to provide the collision detection optical fiber sensor 100 by combining the linear member 2 or 3 in the first preferred embodiment with the linear member 8 or 9 in the third preferred embodiment.

Further, the first linear member groups of the first linear members and the second linear member groups of the second linear members may be disposed alternately or continuously around the optical fiber 1. For example, two first linear member groups each comprising two first linear members and two second linear member groups each comprising two second linear members may be arranged alternately.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A collision detection optical fiber sensor, comprising:
an optical fiber including a core and a cladding material;
a first linear member having an elasticity and twisted around an outer periphery of the cladding material; and
a second linear member having an elasticity different from that of the first linear member, and twisted around the outer periphery of the cladding material together with the first linear member.

2. The collision detection optical fiber sensor according to claim 1, wherein the first linear member and the second linear member are disposed alternately along a circumferential direction of the optical fiber to be twisted around the optical fiber.

3. The collision detection optical fiber sensor according to claim 1, wherein a first linear member group comprising a plurality of the first linear member and a second linear member group comprising a plurality of the second linear members are disposed alternately along a circumferential direction of the optical fiber to be twisted around the optical fiber.

4. The collision detection optical fiber sensor according to claim 1, wherein each of the first linear member and the second linear member comprises a tension member and an elastic member covering an outer periphery of the tension member.

5. The collision detection optical fiber sensor according to claim 1, wherein each of the first linear member and the second linear member comprises an elastic member with a string-shape.

6. The collision detection optical fiber sensor according to claim 4, wherein a rubber hardness difference measured by a durometer type A according to a JIS K6253 between the elastic member of the first linear member and the elastic member of the second linear member is not less than 10.

7. The collision detection optical fiber sensor according to claim 5, wherein a rubber hardness difference measured by a durometer type A according to a JIS K6253 between the elastic member of the first linear member and the elastic member of the second linear member is not less than 10.

8. The collision detection optical fiber sensor according to claim 4, wherein the elastic member comprises a silicone rubber.

9. The collision detection optical fiber sensor according to claim 5, wherein the elastic member comprises a silicone rubber.

10. The collision detection optical fiber sensor according to claim 4, wherein the tension member comprises a copper wire.

11. The collision detection optical fiber sensor according to claim 1, wherein each of the first linear member and the second linear member consists of an elastic member with a string-shape.
